(19) United States
(12) Patent Application Publication
(10) Pub. No.: US 2013/0103461 A1
(43) Pub. Date: Apr. 25, 2013

(54) COUPON DISTRIBUTION

(71) Applicant: Rajesh Bhatia, Bangalore Kamataka (IN)

(72) Inventor: Rajesh Bhatia, Bangalore Kamataka (IN)

(21) Appl. No.: 13/280,414

(22) Filed: Oct. 25, 2011

(51) Int. Cl. G06Q 30/02

(52) U.S. Cl. 705/14.1

(57) ABSTRACT

In one embodiment, preference data relating to consumer preferences of a user of a network-connected printer is received at a computer system. Association data associating a mobile computing device with the user or the printer is received at the computer system. An electronic coupon is sent to the printer. Proximity data indicating that the mobile device is within a proximity to the printer is received. Responsive to receipt of the proximity data, the printer is caused to send the coupon to the mobile device.

### BACKGROUND

Certain network-connected printers are capable of sending and receiving communications and printable coupons and other content via a network without being connected to a desktop computer, laptop computer, or other host computing device. Such functionality can provide considerable flexibility and efficiencies for a user, as the user may have the ability to download and print the coupons at the printer without the complication of first establishing a connection with a host.

### BRIEF DESCRIPTION OF THE DRAWINGS

The accompanying drawings illustrate various embodiments and are a part of the specification. The illustrated embodiments are examples and do not limit the scope of the claims. Throughout the drawings, identical reference numbers designate similar, but not necessarily identical elements.

FIG. 1 is a block diagram illustrating a system according to various embodiments.

FIG. 2 is a block diagram illustrating a system according to various embodiments.

FIG. 3 is an example associations database, according to various embodiments.

FIG. 4 is a block diagram illustrating a system according to various embodiments.

FIG. 5A is an example display of an electronic coupon according to various embodiments.

FIG. 5B is an example coupon data repository according to various embodiments.

FIG. 6 is a block diagram illustrating a system according to various embodiments.

FIG. 7 is a flow diagram depicting steps taken to implement various embodiments.

The same part numbers designate the same or similar parts throughout the figures.

### DETAILED DESCRIPTION OF EMBODIMENTS

A coupon distributor service can provide printable coupon content to a network-connected printer for printing. After printing the coupon at the printer, a user might carry the hard copy coupon to a retailer and surrender the coupon to secure a discount. There are circumstances, however, in which it will not be convenient or expedient for a user to print hard copy coupons at the network-connected printer. For example, if a coupon distributor service sends a large set of coupons to the internet connected printer for printing, the user may presented with an unpleasant choice of choosing between a time-consuming task of viewing each coupon to determine relevancy, or a choosing to “print all” from the set. Choosing to “print all” presents a risk of expending ink, paper and other resources to print some coupons that are not desired. This situation can negatively affect the user experience regarding the network-connected printer and its utility for securing discounts via coupons.

Further, in some circumstances printing coupons at the network-connected printer will not be most desirable option from the perspective of the issuer of the coupons. Traditional services that provide coupons to network-connected printers for printing may not have the capability to track redemption of the hard copy coupons. Such inability to track coupon redemption can result in reduced revenue for coupon issuers and/or distributors.

Accordingly, various embodiments described herein were developed to provide a method and system whereby users can receive relevant coupons via an internet-connected printer without printing out the coupons. According to an example, a computer system receives data relating to consumer preferences of a user of an internet-connected printer. The computer system additionally receives data associating a smart phone or other mobile computing device with the user or the printer. The computer system sends to the internet-connected printer an electronic coupon that is selected on the basis of the consumer preferences information. Subsequently, the computer system receives data that indicates to the computer system that the mobile device is within a predetermined proximity to the printer. Responsive to the receipt of the proximity data, the computer system sends to the printer a directive to send the electronic coupon to the mobile device. The user might then present the coupon, via the mobile device, to a redeeming computer in order to secure a purchase discount, rental discount, or other commercial discount. It should be noted that while the disclosure is discussed frequently with reference to internet-connected printers, the teachings of the present disclosure are not so limited and can be applied to any network-connected printer.

As used herein, a “network-connected printer” refers to a printer that is connected to a network, to be capable of obtaining content, sending and receiving messages, accessing network content, and/or accessing applications via a network. In examples, the network may be a proprietary network, a secured network, an open network, an intranet, an extranet, an internet or the Internet. “Content” refers to any text, image, or other information that can be received by and stored at computer system for later display, printing, or other presentation to a user. “Printer” or “printing device” refers to any electronic device that prints and includes multifunctional electronic devices that perform additional functions such as scanning and/or copying. The terms “mobile computing device” and “mobile device” are used synonymously, and refer to any portable computing device capable of communicating with another computing device. “Coupon” refers to a certificate, voucher, document, instrument, writing, image, or other display of information that entitles a recipient to receive a benefit, e.g., a discount, refund, reward, gift, money, or other thing or service. “Electronic coupon” refers to a coupon in digital or content format, such that the coupon can be received by and stored at a computer system for later display, printing or other presentation to a user. “Redemption” refers to acceptance or honoring of a coupon such that the party presenting the coupon is afforded a benefit attached to or associated with the coupon.

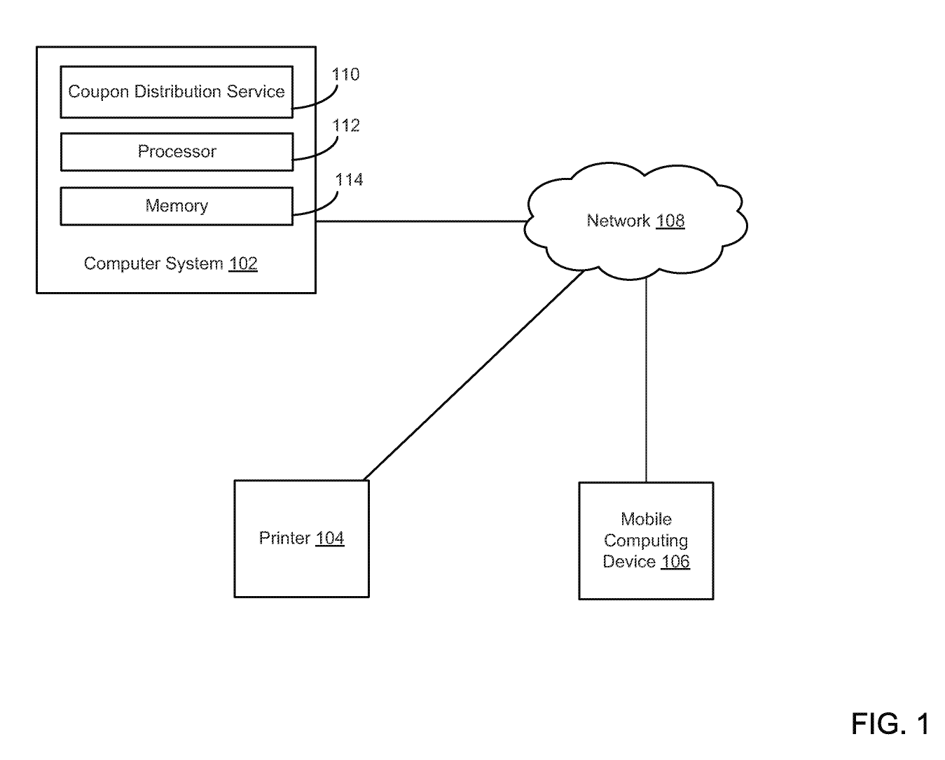

FIG. 1 is a block diagram illustrating a system according to various embodiments. FIG. 1 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

FIG. 1 shows a computer system 102, a printer 104, and a mobile computing device 106 connected to a network 108. Computer system 102 represents generally any computing device or group of computing devices capable of sending network requests and content to, and otherwise communicating with printer 104. In embodiments, computer system 102 may be or include a server, desktop computer, laptop computer, mobile device, tablet computer, and/or any other computing device. Printer 104 represents generally a computing device that is operable to produce printed output, and additionally operable to send network requests and content to, receive network requests and content from, and otherwise communicate with each of computer system 102 and mobile device 106 over network 108. Mobile device 106 represents generally any portable computing device capable of sending network requests and content to, and otherwise communicating with printer 104 via network 108. In embodiments, mobile device 106 may be a smart phone, tablet computer, or laptop computer.

Network 108 represents generally hardware components and computers interconnected by communications channels that allow sharing of resources and information. Network 108 may include one or more of a cable, wireless, fiber optic, or remote connection via a telecommunication link, an infrared link, a radio frequency link, or any other connectors or systems that provide electronic communication. Network 108 may include, at least in part, an intranet, the internet, or a combination of both. Network 108 may also include intermediate proxies, routers, switches, load balancers, and the like. The paths followed by network 108 between computer system 102, printer 104, and mobile device 106 as depicted in FIG. 1 represent the logical communication paths between these devices, not necessarily the physical paths between the devices.

Computer system 102 includes a coupon distribution service 110. Coupon distribution service 110 represents generally any combination of hardware and programming configured to enable the provision of pertinent electronic coupons to mobile device 106 via network-connected printer 104. In one example, coupon distribution service 110 receives preference data relating to consumer coupon preferences of a user of a network-connected printer 104. In embodiments, coupon distribution service 110 may receive the preference data from printer 104 (e.g., the preference data may be received at the printer from a user via user interface at printer 104). In other embodiments, coupon distribution service 110 may receive the preference data from mobile device 106 (e.g., the preference data may be received via a print-related application executing at or available at mobile device 106). In other embodiments, coupon distribution service 110 may receive the preference data from a computing device that is neither the printer 104 nor mobile device 106.

Coupon distribution service 110 additionally receives data that associates mobile device 106 with the user of printer 104 described in the preceding paragraph, or that associates mobile device 106 with printer 104 itself. In embodiments, coupon distribution service 110 may receive the association data from printer 104 (e.g., the association data may be received at the printer from a user via user interface at printer 104). In other embodiments, the association data may be received from mobile device 106. For example, the association data that is received at coupon distribution service 110 from mobile device 106 may be data that was supplied by a user to mobile device 106 via a personal information application or other programming executing or otherwise available to the user at mobile device 106. In other embodiments, the association data may be received from a computing device that is neither printer 104 nor mobile device 106.

Coupon distribution service 110 sends to printer 104 an electronic coupon selected in consideration of the preference data, for storage at printer 104. Coupon distribution service 110 receives data indicating that mobile device 106 is within a pre-defined proximity to printer 104. In embodiments, coupon distribution service 110 receives the proximity data from printer 104. For example, the proximity data may be data that printer 104 sends to coupon distribution service 110 responsive to detection of the establishing of a communication connection between printer 104 and mobile device 106. In other embodiments, the coupon distribution service may receive proximity data (e.g. global positioning system (“GPS”) data) from mobile device 106, or from a server system that is in communication with mobile device 106. Upon the coupon distribution service's 110 receipt of the proximity data, the service 110 sends an electronic communication to printer 104 that causes printer 104 in turn to send the selected electronic coupon to mobile device 106. In an embodiment, coupon distribution service 110 is configured to send a message (e.g., to mobile device 106 or to another computing device) that the coupon is available for electronic pickup at the printer.

In an embodiment, the electronic coupon that is sent to printer 104 includes a tracking code that enables coupon distribution service 110 to track or detect redemption and/or nonredemption of the coupon. In example, coupon distribution service 110 may cause the updating of a revenue or payment tracking database in connection with receipt of data that references the tracking code and is an indicator of redemption of the electronic coupon. In another example, coupon distribution service 110, responsive to not receiving such redemption data within a prescribed time period, may cause the sending of a reminder message (e.g., to mobile device 106 or another computing device) stating the coupon is available for electronic pickup at printer 104.

In yet another embodiment, the coupon distribution service 110 is configured to receive a request to share, with a recipient device, the electronic coupon that is sent to printer 104. The share request may be received at coupon distribution service 110 from printer 104, mobile device 106, or another computing device. Responsive to receipt of the request, and after confirming via shareability data in a coupon data repository that the coupon is a sharable coupon, coupon distribution service 110 sends the coupon to the recipient device.

The functions and operations described with respect to coupon distribution service 110 and computer system 102 may be implemented as a computer-readable storage medium containing instructions executed by a processor (e.g., processor 112) and stored in a memory (e.g., memory 114). In a given implementation, processor 112 may represent multiple processors, and memory 114 may represent multiple memories. Processor 112 represents generally any instruction execution system, such as a computer/processor based system or an ASIC (Application Specific Integrated Circuit), a computer, or other system that can fetch or obtain instructions or logic stored in memory 114 and execute the instructions or logic contained therein. Memory 114 represents generally any memory configured to store program instructions and other data.

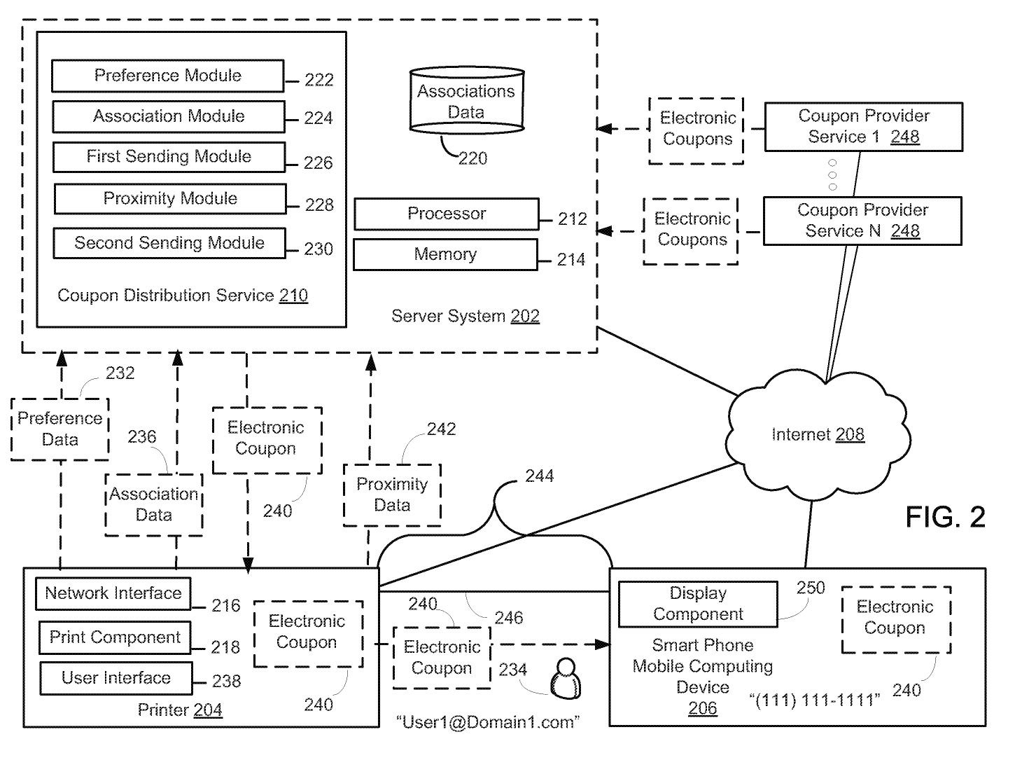

FIG. 2 is a block diagram that includes a server system 202 according to various embodiments. FIG. 2 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

FIG. 2 shows server system 202, printer 204, smart phone mobile computing device 206, and coupon provider services 1-N 248 connected to internet 208. Smart phone 206 represents generally any mobile computing device capable of sending network requests and content to, receiving network requests and content from, and otherwise communicating with printer 204 via internet 208. Each of the coupon provider services 1-N 248 represents generally any computing device or group of computing devices capable of sending network requests and content to, and otherwise communicating with server system 202 via internet 208.

Printer 204 is shown to include a network interface 216 and a print component 218. Network interface 216 represents generally any combination of hardware and programming configured for electronically connecting printer 204 to internet 208. Print component 218 represents generally any combination of hardware and programming configured to produce printed output.

Server system 202 represents generally any computing device or group of computing devices capable of accepting, processing, storing and outputting data according to programmed instructions. As illustrated in FIG. 2, server system 202 may be a single physical device or it may be distributed among multiple physical devices connected over a network (e.g., the Internet). For example, server system 202 may represent a cloud computing infrastructure (i.e., the cloud). In a cloud computing infrastructure, various components/modules of server system 202 may share resources and/or act in concert even though they might be in different physical locations and/or operating on different physical devices.

Server system 202 is shown to include a coupon distribution service 210 and an associations database 220. Coupon distribution service 210 represents generally any combination of hardware and programming configured to enable distribution of electronic coupons to mobile devices via network connected printers. Coupon distribution service 210 includes preference module 222, association module 224, first sending module 226, proximity module 228, and second sending module 230. Associations database 220 represents generally any combination of hardware and programming configured to store data associating mobile computing devices with network connected printers or users of network connected printers.

In the example of FIG. 2, preference module 222 receives preference data 232 from network connected printer 204. The preference data 232 is data relating to consumer preferences of a user 234 of printer 204. Preference data 232 may be a history of goods and/or services that user 234 purchases utilizing smart phone 236, or a more general purchase or other consumption history regarding user 234. The preference data 232 may be data that user 234 inputs directly at printer 204 via a user interface at printer 204. In another example, preference data 232 is data obtained at printer 204 via internet 208 from a service that that user 234 has authorized to track credit card, debit card, retailer-specific or other types of purchases made by user 234. In an example, the preference data may be a history of coupons that user 234 has previously received via printer 204 from server system 202. In an example, the preference data may be a history of coupons that printer 204 has received from computing devices other than server system 202.

Association module 224 receives association data 236 that associates smart phone 206 with the user 234 of printer 204, or that associates smart phone 206 with printer 204 itself. In the example depicted in FIG. 2, association module 224 receives the association data from printer 204. Association data 236 may be received at printer 204 from user 234 via the user's interaction with a keypad, touchscreen, or other user interface 238 at printer 204. The association data 236 that is received at association module 224 may be stored at an associations database 220 within server system 202, or in a database or memory external to server system 202.

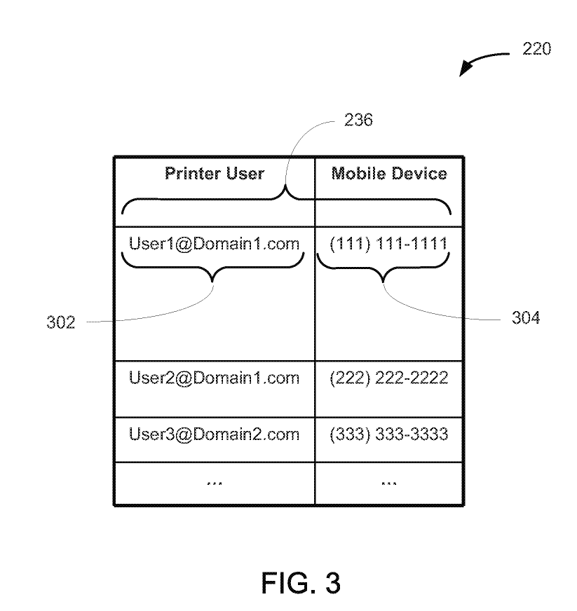

FIG. 3, in view of FIG. 2, depicts an example associations database 220 that includes associations data 236. In this example, a user 234 of printer 204 is identified in the associations database 220 according to an email address “User1@Domain1.com” 302. The association data 236 received at server system 202 from printer 204 associates user 234 (via the email address) with a smart phone mobile device 206 that is identified according to a mobile telephone number “(111) 111-1111” 304.

Returning to FIG. 2, first sending module 226 sends to printer 204 an electronic coupon 240 selected in consideration of preference data 232. In this example, the coupon is stored at printer 204. For example, in response to preference data 232 indicative that user 234 has on several occasions requested from server system 202 coupons relating to automotive products, server system 202 may select and send to user 234 a set of coupons that are deemed relevant for user 234 and that will entitle user 234 to discounts on automotive products upon redemption. In this example, the coupon 240 is a coupon obtained by server system 202 from one of coupon provider services 1-N 248.

Proximity module 228 receives from printer 204 data indicating that smart phone 206 is within a pre-defined proximity 244 to printer 204. In the example of FIG. 2, printer 204 sends proximity data 242 to coupon distribution service 210 responsive to printer 204 establishing a communication connection 246 between printer 204 and smart phone 206. In examples, the communication connection 246 triggers the sending of the proximity data 242 may be a connection via a nearfield protocol, a Bluetooth™ connection, a Wi-Fi™ connection, another form of wireless connection, or a wired connection.

Upon the proximity module's 228 receipt of proximity data 242, second sending module 230 sends an instruction, message, command, request or other directive to printer 204 that causes printer 204 in turn to send electronic coupon 240 to smart phone 206. User 234 is now enabled to display electronic coupon 240 to a merchant or the coupon redeeming entity via a touchscreen or other display component included within smart phone 206. In another example, user 234 may be enabled to transfer the received coupon 240, or a copy of received coupon 240, to a coupon redeeming entity via Wi-Fi™ connection, Bluetooth™ connection, infrared connection, nearfield protocol, other wireless communication or protocol, or other means.

In embodiments, the sending and receipt of preference data 232, association data 236, electronic coupon 240, and/or proximity data 242 may be via a networking protocol, including but not limited to Transmission Control Protocol/Internet Protocol (“TCP/IP”), HyperText Transfer Protocol (“HTTP”), Simple Mail Transfer Protocol (“SMTP”), Extensible Messaging and Presence Protocol (“XMPP”) and/or Session Initiation Protocol (“SIP”).

The functions and operations described with respect to coupon distribution service 210 and server system 202 may be implemented as a computer-readable storage medium containing instructions executed by a processor (e.g., processor 212) and stored in a memory (e.g., memory 214). In a given implementation, processor 212 may represent multiple processors, and memory 214 may represent multiple memories.

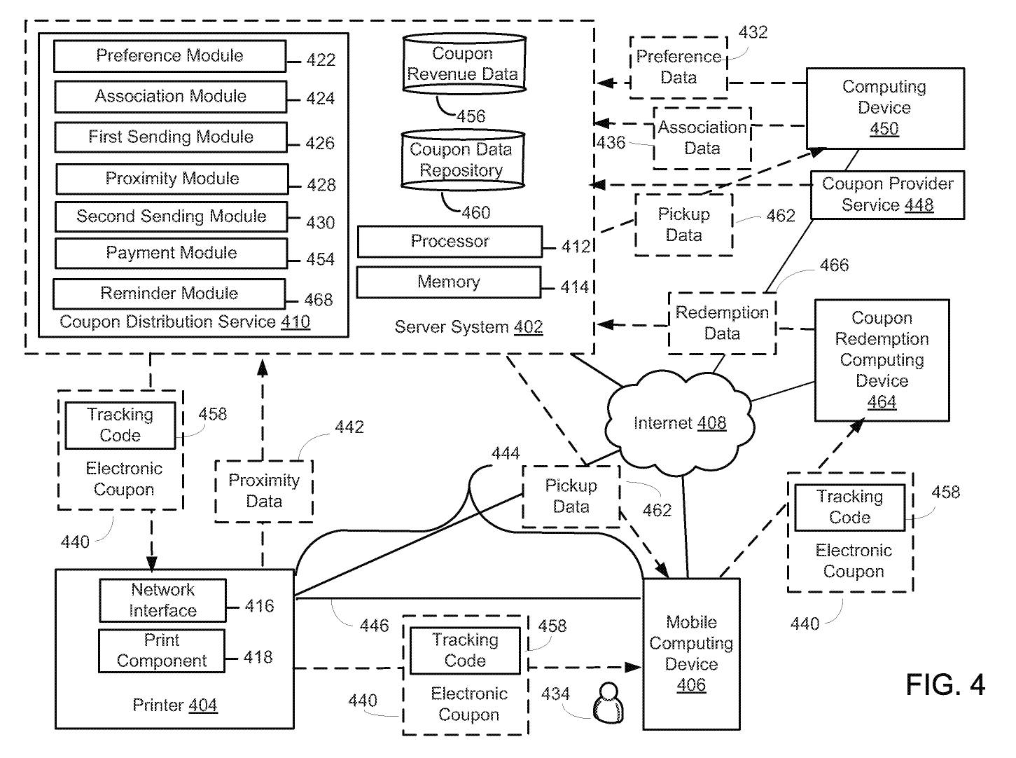

FIG. 4 is a block diagram that includes a server system 402 according to various embodiments. FIG. 4 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

FIG. 4 shows server system 402, printer 404, mobile computing device 406, computing device 450, and coupon redemption computing device 452 connected to internet 408. Mobile device 406 represents generally any mobile computing device capable of sending network requests and content to, receiving network requests and content from, and otherwise communicating with printer 404 via internet 408. Computing device 450 represents generally any computing device or group of computing devices capable of sending network requests, preference data, association data, and content to, receiving pickup data from, and otherwise communicating with server system 402 via internet 408. In examples, computing device may be desktop computer, laptop computer, table computer, mobile computing device, or any other type of computing device. Coupon redemption computing device 464 represents generally any computing device or group of computing devices capable of sending network requests, redemption data, other content, or otherwise communicating with server system 402 via internet 408.

Printer 404 is shown to include a network interface 416 and a print component 418. Network interface 416 represents generally any combination of hardware and programming configured for electronically connecting printer 404 to internet 408. Print component 418 represents generally any combination of hardware and programming configured to produce printed output.

Server system 402, represents generally any computing device or group of computing devices capable of accepting, processing, storing and outputting data according to programmed instructions. As illustrated in FIG. 4, server system 402 may be a single physical device or it may be distributed among multiple physical devices connected over a network (e.g., the Internet). For example, server system 402 may represent a cloud computing infrastructure (i.e., the cloud). In a cloud computing infrastructure, various components/modules of server system 402 may share resources and/or act in concert even though they might be in different physical locations and/or operating on different physical devices.

Server system 402 is shown to include a coupon distribution service 410, a coupon revenue database 456, a coupon data repository 460. Coupon distribution service 410 represents generally any combination of hardware and programming configured to enable coupon distribution to mobile devices via network connected printers. Coupon distribution service 410 includes preference module 422, association module 424, first sending module 426, proximity module 428, second sending module 430, payment module 454, and reminder module 468. Coupon revenue database 420 represents generally any combination of hardware and programming configured to store data regarding payments due to a coupon provider entity n connection with redemption of coupons. Coupon data repository 460 represents generally any combination of hardware and programming configured to store information relating to electronic coupons, organized by tracking codes for the coupons

In the example of FIG. 4, preference module 422 receives preference data 432 regarding consumer preferences of user 434 from computing device 450. In this example, user 434 is a user of printer 404, mobile device 406, and a tablet computing device 450, and user 434 utilizes computing device 450 to send coupon preference data to server system 402.

Association module 424 receives from computing device 450 association data 436 that associates mobile device 406 with the user 434 of printer 404, or that associates mobile device 406 with printer 404 itself. Association data 436 may be received at printer 404 from user 434 via the user's 434 interaction with a keypad, touchscreen, or other user interface at tablet computing device 450. The association data 436 that is received at server system 402 may be stored within a database or memory at server system 402, or external to server system 402.

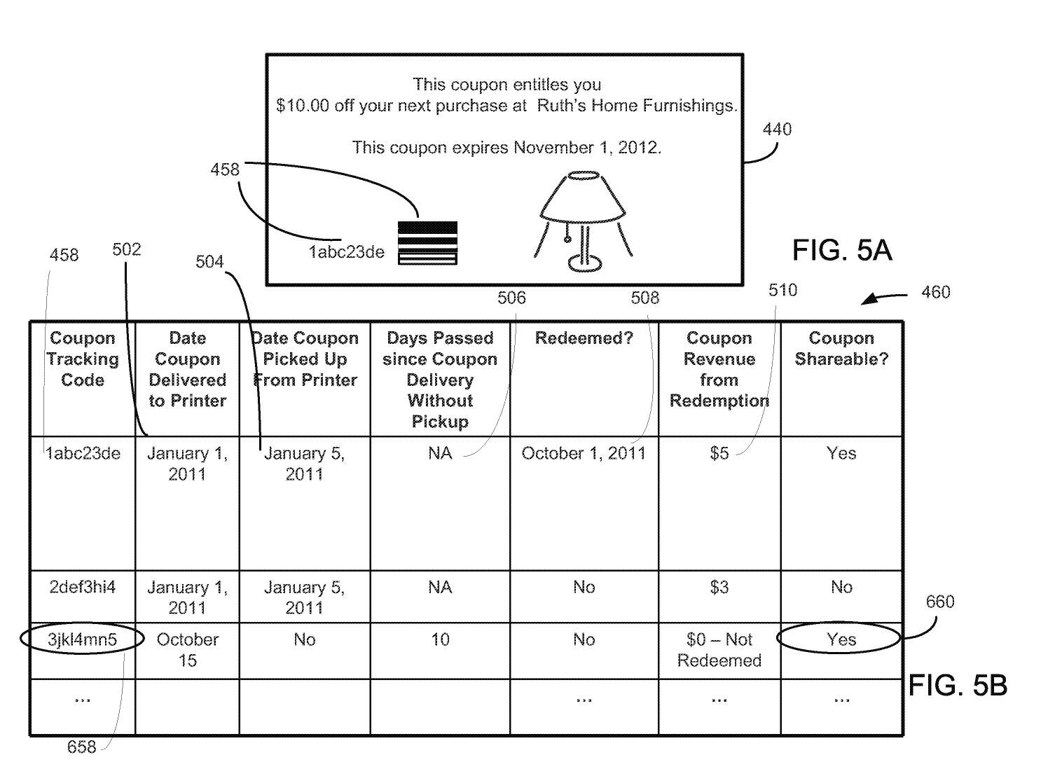

First sending module 426 sends to printer 404 an electronic coupon 440 selected in consideration of preference data 432. FIG. 5A provides an example of an electronic coupon. In this example, electronic coupon 440 includes a tracking code 458 “1abc23de” in text and in one dimensional barcode format. In other embodiments, the tracking code 458 may be in the form of a QR code or other two dimensional barcode, three dimensional barcode, or any other encoded format. The tracking code 458 enables tracking or detect of redemption and/or nonredemption of the coupon.

Server system 402 holds in memory a coupon data repository 460 that stores information relating to the tracking code 458 and the electronic coupon 440 that is sent to printer 404. FIG. 5B provides an example of a coupon data repository 460. In this example, coupon data repository 460 includes information, associated with the tracking code 458, as to the date that the coupon 440 is delivered 502 by server system 402 to printer 404, the date that coupon is picked up 504 from printer 404 by a mobile device 406, days passed since coupon delivery without pickup 506, and the date of redemption 508 of the coupon.

Returning to FIG. 4, in this example reminder module 468 sends pickup data 462 to computing device 450 and/or to mobile computing device 406 to cause a display of messages at those devices that the coupon 440 is available for electronic pickup at printer 404. In embodiments, the pickup data 462 is sent to computing device 450 and/or mobile device 406 via email. In an embodiment, the pickup data is sent to computing device 450 and/or mobile device 406 via an instant message. In one embodiment, reminder module sends pickup data 462 to mobile device 406 and/or computing device 450 responsive to the passage of a prescribed period of time without server system 402 having received redemption data for coupon 440.

Proximity module 428 receives from printer 404 data indicating that mobile device 406 is within a pre-defined twenty meter proximity 444 to printer 404. In the example of FIG. 4, printer 404 sends proximity data 442 to coupon distribution service 410 responsive to printer 404 establishing a Wi-Fi™ communication connection 446 between printer 404 and mobile device 406. The establishing of the Wi-Fi™ connection is evidence of a the mobile device 406 being within the approximate twenty meter proximity 444 of printer 404. In another example, the communication connection 446 that triggers the sending of the proximity data 442 may be a connection via a nearfield protocol, the connection suggesting a proximity 444 between mobile device and printer of less than or equal to approximately twenty centimeters. In another example, the communication connection 446 that triggers the sending of the proximity data 442 may be a connection via a Bluetooth™ protocol, with the connection suggesting a proximity 444 between mobile device and printer of less than or equal to approximately ten meters.

Upon the proximity module's 428 receipt of proximity data 442, second sending module 430 sends an instruction, message, command, request or other directive to printer 404 that causes printer 404 in turn to send electronic coupon 440 to mobile device 406.

In this example, user 434 next displays, transfers, or sends a copy of the electronic coupon 440 to a coupon redemption computing device 464 of a redeeming merchant. In embodiments, the transfer may be via Wi-Fi™, Bluetooth™, infrared, nearfield protocol, other wireless communication, or other means. Upon redemption, the coupon redemption computing device 464 sends to server system 402 via internet 408, and payment module 454 receives, redemption data 466 referencing the electronic coupon's 440 tracking code 458. Upon receipt of the redemption data 466, payment module 454 updates a coupon revenue database 456 to indicate a payment is due in connection with the redemption. In the example of FIG. 4, the coupon revenue database 456 is included within server system 402. In other embodiments, the coupon revenue database may be external to server system 402. In an example, the update to the coupon revenue database is to indicate that a $5.00 payment 510 (FIG. 5B) is to be made to a coupon provider service 448 that provided coupon 440 to server system 402.

The functions and operations described with respect to coupon distribution service 410 and server system 402 may be implemented as a computer-readable storage medium containing instructions executed by a processor (e.g., processor 412) and stored in a memory (e.g., memory 414). In a given implementation, processor 412 may represent multiple processors, and memory 414 may represent multiple memories.

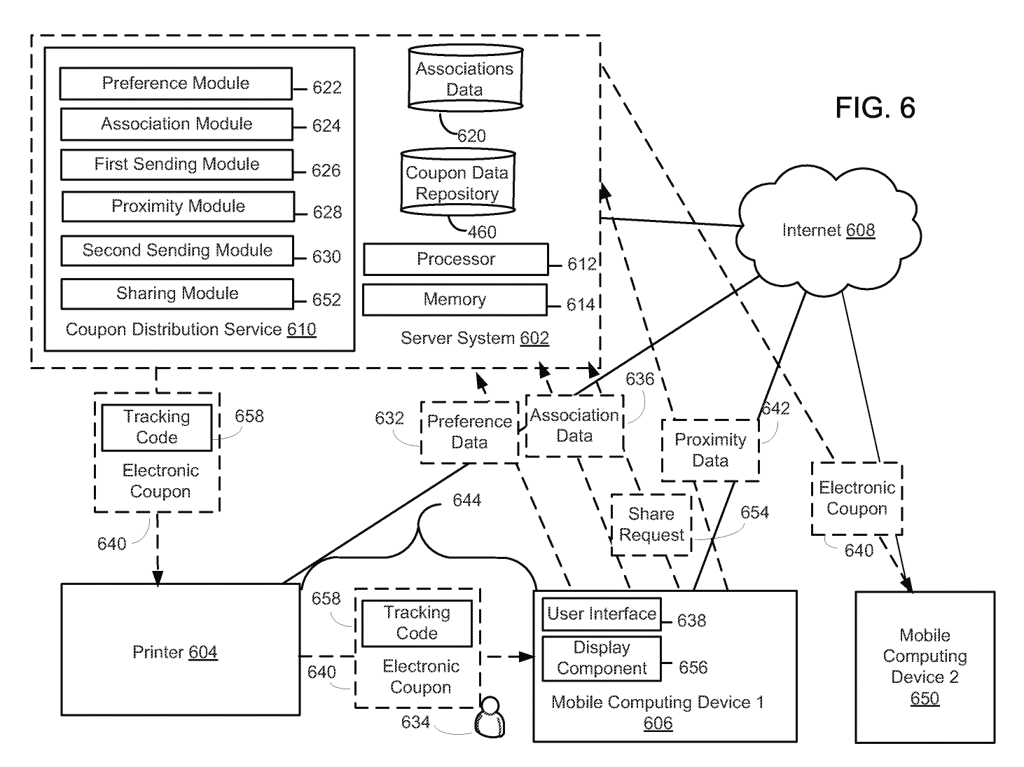

FIG. 6 is a block diagram that includes a server system 602 according to various embodiments. FIG. 6 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

FIG. 6 shows server system 602, printer 604, a first mobile computing device 606 and a second mobile computing device 650 connected to internet 608. First mobile device 606 represents generally any mobile computing device capable of sending network requests and content to, receiving network requests and content from, and otherwise communicating with printer 604 via internet 608. Second mobile device 650 represents generally any mobile computing device capable of sending network requests and content to, receiving network requests and content from, and otherwise communicating with server system 602.

Printer 604 represents generally represents generally any combination of hardware and programming configured to produce printed output, and to send network requests and content to, receive network requests and content from, and otherwise communicate with coupon distribution service 610 and first mobile device 606 via internet 608.

Server system 602 is shown to include a coupon distribution service 610, an associations database 620, and coupon data repository 460. Coupon distribution service 610 represents generally any combination of hardware and programming configured to enable coupon distribution to mobile devices via network connected printers. Coupon distribution service 610 includes preference module 622, association module 624, first sending module 626, proximity module 628, second sending module 630, and a sharing module 652. Association module 620 represents generally any combination of hardware and programming configured to store data associating mobile computing devices with network connected printers or users of network connected printers. Coupon data repository 460 represents generally any combination of hardware and programming configured to hold coupon tracking codes, coupon shareability data, and other data related to electronic coupons distributed by server system 602.

In the example of FIG. 6, preference module 622 receives preference data 632 from network connected printer 604. Association module 624 receives association data 636 that associates first mobile device 606 with the user 634 of printer 604, or that associates first mobile device 606 with printer 604 itself. In the example depicted in FIG. 6, association module 624 receives the association data from first mobile device 606. Association data 636 may be received at first mobile device 606 from user 634 via the user's interaction with a keypad, touchscreen, or other user interface 638 at first mobile device 606. The association data 636 that is received at server system 602 may be stored at an associations database 620 within server system 602, or in a database or memory external to server system 602.

First sending module 626 sends to printer 604 an electronic coupon 640 selected in consideration of preference data 632. The coupon 640 includes a tracking code 658 and is stored at printer 604. Proximity module 628 receives from first mobile device 606 data indicating that first mobile device 606 is within a pre-defined proximity to printer 604. In the example of FIG. 6, first mobile device 606 sends GPS coordinate information relating the position of first mobile device 606, and proximity module 628 compares the GPS information with the GPS coordinates or other location information regarding printer 604. In an example, if the predefined proximity 644 is one kilometer, and a comparison of GPS coordinates of first mobile device 606 and printer 604 reveals the a proximity of less than or equal to one kilometer, the proximity condition is satisfied and the coupon distribution procedure continues.

Upon the proximity module's 628 receipt of proximity data 642, second sending module 630 sends an instruction, message, command, request or other directive to printer 604 that causes printer 604 in turn to send electronic coupon 640 to first mobile device 606. User 634 is now enabled to display electronic coupon 640 to a merchant or the coupon redeeming entity via a touchscreen or other display component 656 included within first mobile device 606.

Sharing module 652 is configured to receive a request from first mobile device 606 to share the electronic coupon 640 with a recipient computing device. In this example, user 634 causes first mobile device 606 to send a request 654 to share coupon 640 with the second mobile device 650. Moving to FIG. 5B, sharing module 652 validates that the coupon 640 can be shared by comparing the tracking code 658 to shareability data 660 held in coupon data repository 460. In this example, sharing module 652 can confirm via the “Yes” 660 in the “Coupon Shareable” column of the database that a coupon 640 with tracking code “3jkl4mn5” is shareable. Returning to FIG. 6, after such validation, sharing module 652 sends the electronic coupon 640 to the second mobile device 650. In embodiments, the shared coupon 640 sent to the second mobile device 640 is the same, or substantially the same, as the coupon 640 that was first sent to the first mobile device 606.

The functions and operations described with respect to coupon distribution service 610 and server system 602 may be implemented as a computer-readable storage medium containing instructions executed by a processor (e.g., processor 612) and stored in a memory (e.g., memory 614). In a given implementation, processor 612 may represent multiple processors, and memory 614 may represent multiple memories.

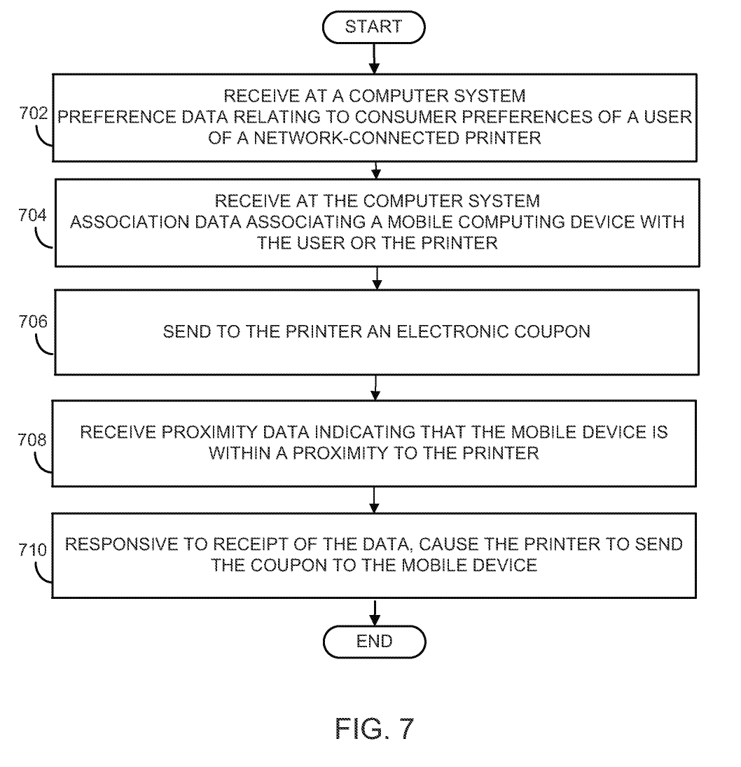

FIG. 7 is a flow diagram of operation in a system according to various embodiments. In discussing FIG. 7, reference may be made to the diagrams of FIGS. 2, 4, and 6 to provide contextual examples. Implementation, however, is not limited to those examples. Starting with FIG. 7, preference data is received at a computer system. The preference data relates to consumer preferences of a user of a network-connected printer (block 702). Referring back to FIGS. 2, 4, and 6, preference module 222, 422, or 622 may be responsible for implementing block 702.

Continuing with the flow diagram of FIG. 7, data is received that associates a mobile device with the user of the network printer, or with the printer itself (block 704). Referring back to FIGS. 2, 4, and 6, association module 224, 424, or 624 may be responsible for implementing block 704.

Continuing with the flow diagram of FIG. 7, an electronic coupon is sent to the printer (block 706). Referring back to FIGS. 2, 4, and 6, first sending module 226, 426, or 626 may be responsible for implementing block 706.

Continuing with the flow diagram of FIG. 7, proximity data is received. The proximity data indicates that the mobile device is within a proximity to the printer (block 708). Referring back to FIGS. 2, 4, and 6, proximity module 228, 428, or 628 may be responsible for implementing block 708.

Continuing with the flow diagram of FIG. 7, responsive to receipt of the proximity data, the printer is caused to send the coupon to the mobile device (block 710). Referring back to FIGS. 2, 4, and 6, second sending module 230, 430, or 630 may be responsible for implementing block 710.

Although the flow diagram of FIG. 7 shows specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present disclosure.

Various modifications may be made to the disclosed embodiments and implementations without departing from their scope. Therefore, the illustrations and examples herein should be construed in an illustrative, and not a restrictive, sense.

What is claimed is:

1. A computer-readable storage medium containing instructions for coupon distribution via network-connected printers, the instructions when executed by a processor causing the processor to:
receive at a computer system
preference data relating to consumer preferences of a user of a network-connected printer;
association data associating a mobile computing device with the user or the printer;
send to the printer an electronic coupon;
receive proximity data indicating that the mobile device is within a proximity to the printer; and
responsive to receipt of the proximity data, cause the printer to send the coupon to the mobile device.

2. The medium of claim 1, wherein the preference data is coupon preference data.

3. The medium of claim 1, wherein the preference data is sent to the computer system from the printer.

4. The medium of claim 1, wherein the preference data is sent to the computer system from the mobile device.

5. The medium of claim 1, wherein the preference data is sent to the computer system from a computing device that is not the printer or the mobile device.

6. The medium of claim 1, wherein the association data is sent to the computer system from the printer.

7. The medium of claim 1, wherein the association data is sent to the computer system from the mobile device.

8. The medium of claim 1, wherein the association data is sent to the computer system from a computing device that is not the printer or the mobile device.

9. The medium of claim 1, wherein the proximity data is received from the printer.

10. The medium of claim 9, wherein the proximity data is data sent by the printer responsive to the establishing of a communication connection between the printer and the mobile device.

11. The medium of claim 9, wherein the connection is via a nearfield protocol, Bluetooth connection, or Wi-Fi connection.

12. The medium of claim 1, wherein the proximity data is received from the mobile device and includes GPS coordinates.

13. The medium of claim 1, wherein the instructions further cause the processor to send pickup data to cause display of a message that the coupon is available for electronic pickup at the printer.

14. The medium of claim 13, wherein pickup data is sent via email or instant message.

15. The medium of claim 13, wherein the pickup data is sent to the mobile device to cause display of the message at the mobile device.

16. A system to distribute coupons via network-connected printers, comprising:
a preference module, configured to receive at a computer system preference data relating to consumer preferences of a user of a network-connected printer;
an association module, configured to receive at the computer system association data associating a mobile computing device with the user or the printer;
a first sending module, configured to send to the printer an electronic coupon;
a proximity module, configured to receive proximity data indicating that the mobile device is within a proximity to the printer;
a second sending module, configured to, responsive to receipt of the proximity data, cause the printer to send the coupon to the mobile device.

17. The system of claim 16,
wherein the coupon includes a tracking code; and
further comprising a payment module configured to
receive redemption data referencing the tracking code; and
update a coupon revenue database to indicate payment is due in connection with the redemption.

18. The system of claim 16,
wherein the coupon includes a tracking code; and
further comprising a reminder module, configured to send pickup data to cause display of a message that the coupon is available for electronic pickup at the printer, responsive to a passage of a time without receipt of redemption data referencing the tracking code.

19. The system of claim 16, further comprising a sharing module configured to:
receive a request to share the coupon with a recipient computing device,
validate that the coupon can be shared by comparing the tracking code to shareability data in a coupon data repository,
send the coupon to the recipient device.

20. A computer-readable storage medium containing instructions for coupon distribution via network-connected printers, the instructions when executed by a processor causing the processor to:
receive at a computer system
preference data relating to consumer preferences of a user of a network-connected printer;
association data associating a mobile computing device with the user or the printer;
send to the printer an electronic coupon;
send pickup data to cause display of a message that the coupon is available for electronic pickup at the printer
receive proximity data indicating that the mobile device is within a proximity to the printer,
wherein the proximity data is data sent by the printer responsive to the establishing of a communication connection between the printer and the mobile device; and
responsive to receipt of the proximity data, cause the printer to send the coupon to the mobile device.
